(19) United States
(12) Patent Application Publication
(10) Pub. No.: US 2022/0337605 A1
(43) Pub. Date: Oct. 20, 2022

(54) MANAGEMENT APPARATUS, NETWORK MONITORING SYSTEM, DETERMINATION METHOD, COMMUNICATION METHOD, AND NON-TRANSITORY COMPUTER READABLE MEDIUM

(71) Applicant: NEC Corporation, Minato-ku, Tokyo (JP)

(72) Inventors: Hidehisa TOYAMA, Tokyo (JP); Yoshimitsu Wada, Tokyo (JP); Masahiko Honda, Tokyo (JP)

(73) Assignee: NEC Corporation, Minato-ku, Tokyo (JP)

(21) Appl. No.: 17/763,361

(22) PCT Filed: Sep. 30, 2019
(86) PCT No.: PCT/JP2019/038463

§ 371 Date: Mar. 24, 2022

(51) Int. Cl. H04L 9/40

(52) U.S. Cl. CPC H04L 63/1416; H04L 63/20

(57) ABSTRACT

An object is to provide a management apparatus for reducing undeclared claims for cyber attacks. A management apparatus (10) according to a first example aspect of the present disclosure includes a data collection unit (11) for collecting, from a security apparatus configured to monitor a network managed by a cyber insurance policyholder, security information related to data indicating a suspected occurrence of a cyber attack and detected based on a predetermined communication pattern and a determination unit (12) for determining whether or not the security information satisfies a coverage trigger condition by using a database for managing the coverage trigger condition, the coverage trigger condition defining a coverage criteria of cyber insurance.

### TECHNICAL FIELD

The present disclosure relates to a management apparatus, a network monitoring system, a determination method, a communication method, and a non- transitory computer readable medium.

### BACKGROUND ART

In recent years, various measures have been taken against the threat of cyber attacks on personal networks such as homes or enterprise networks (hereinafter referred to enterprise networks and the like). For example, measures such as a detection of unauthorized intrusion into the enterprise networks and the like and prevention of unauthorized intrusion into the enterprise networks and the like are taken.

In addition, services for compensating for damages caused by cyber attacks on the enterprise networks and the like by using insurance have also spread. Patent Literature 1 discloses a system for compensating for damages caused by unauthorized acts, including theft, tampering, and destruction of data, caused by unauthorized intrusion into a network of a user protected by a firewall. The system disclosed in Patent Literature 1 includes a database in which user identification information and insurance premiums of data on the user's network are registered. The system disclosed in Patent Literature 1 automatically determines an insurance payment to be given to the user by using information indicating data which has been subjected to an unauthorized act, identification information of the user, and the database when it is found that the unauthorized act has occurred in the user's network.

### CITATION LIST

### Patent Literature

Patent Literature 1: Japanese Unexamined Patent Application Publication No. 2003-345989

### SUMMARY OF INVENTION

### Technical Problem

However, when the system disclosed in Patent Literature 1 is used, the insurance payment is not automatically determined until after actual damage has occurred to the user's network. Therefore, if it takes a long time to identify the damage or if the damage cannot be grasped, there is a problem that it is highly likely that the user may fail to declare a claim to the insurance company for insurance regarding the damage that has occurred.

An object of the present disclosure is to provide a management apparatus, a network monitoring system, a determination method, a communication method, and a non-transitory computer readable medium for reducing undeclared claims for cyber attacks.

### Solution to Problem

In a first example aspect of the present disclosure, a management apparatus including: a data collection unit configured to collect, from a security apparatus configured to monitor a network managed by a cyber insurance policyholder, security information related to data indicating a suspected occurrence of a cyber attack and detected based on a predetermined communication pattern; and a determination unit configured to determine whether or not the security information satisfies a coverage trigger condition by using a database for managing the coverage trigger condition, the coverage trigger condition defining a coverage criteria of cyber insurance.

In a second example aspect of the present disclosure, a network monitoring system includes: a security apparatus configured to monitor a network managed by a cyber insurance policyholder and detect data indicating a suspected occurrence of a cyber attack based on a predetermined communication pattern; and a management apparatus configured to collect security information related to the detected data from the security apparatus and determine whether or not the security information satisfies a coverage trigger condition by using a database for managing the coverage trigger condition, the coverage trigger condition defining a coverage criteria of cyber insurance.

In a third example aspect of the present disclosure, a determination method includes: collecting, from a security apparatus configured to monitor a network managed by a cyber insurance policyholder, security information related to data indicating a suspected occurrence of a cyber attack and detected based on a predetermined communication pattern; and determining whether or not the security information satisfies a coverage trigger condition by using a database for managing the coverage trigger condition, the coverage trigger condition defining a coverage criteria of cyber insurance.

In a fourth example aspect of the present disclosure, a communication method executed by a security apparatus for monitoring a network managed by a cyber insurance policyholder includes: detecting data indicating a suspected occurrence of a cyber attack based on a predetermined communication pattern; and transmitting, to a management apparatus, security information related to data satisfying a detection condition determined by the management apparatus for determining whether or not the security information related to the data satisfies a coverage trigger condition from among the data, the coverage trigger condition defining a coverage criteria of cyber insurance.

In a fifth example aspect of the present disclosure, a program for causing a computer to execute: collecting, from a security apparatus configured to monitor a network managed by a cyber insurance policyholder, security information related to data indicating a suspected occurrence of a cyber attack and detected based on a predetermined communication pattern; and determining whether or not the security information satisfies a coverage trigger condition by using a database for managing the coverage trigger condition, the coverage trigger condition defining a coverage criteria of cyber insurance.

### Advantageous Effects of Invention

According to the present disclosure, it is possible to provide a management apparatus, a network monitoring system, and a determination method for reducing undeclared claims for cyber attacks.

### BRIEF DESCRIPTION OF DRAWINGS

FIG. 1 is a configuration diagram of a management apparatus according to a first example embodiment;

FIG. 2 is a configuration diagram of a network monitoring system according to a second example embodiment;

FIG. 3 shows a management apparatus according to the second example embodiment;

FIG. 4 is a block diagram of a security apparatus according to the second example embodiment;

FIG. 5 shows a flow of determination processing related to a coverage trigger according to the second example embodiment;

FIG. 6 shows a flow of database update processing in a management apparatus according to a third example embodiment;

FIG. 7 shows a flow of determination processing related to a coverage trigger according to a fourth example embodiment; and

FIG. 8 is a block diagram of an apparatus according to the respective example embodiments.

### DESCRIPTION OF EMBODIMENTS

### First Example Embodiment

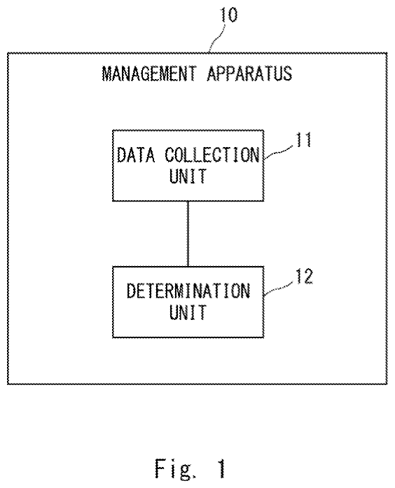

Example embodiments of the present disclosure will be described below with reference to the drawings. A configuration example of a management apparatus 10 according to a first example embodiment will be described with reference to FIG. 1. The management apparatus 10 may be a computer apparatus that operates when a processor executes a program stored in a memory. The management apparatus 10 may be, for example, a server apparatus.

The management apparatus 10 includes a data collection unit 11 and a determination unit 12. The data collection unit 11 and the determination unit 12 may be software or modules in which processing is executed when a processor executes a program stored in the memory. Alternatively, the data collection unit 11 and the determination unit 12 may be hardware such as a circuit or a chip.

The data collection unit 11 collects security information about data indicating a suspected occurrence of a cyber attack and detected based on a predetermined communication pattern from a security apparatus for monitoring a network managed by a cyber insurance policyholder (such a network is hereinafter referred to as a managed network).

Cyber insurance is a service that pays insurance money for cyber attacks on networks. The cyber attack may be, for example, theft, tampering, or destruction of data. The managed network may be, for example, a Local Area Network (LAN) in a home or a company, or an intranet which is a closed network in a company.

The security apparatus may be installed in, for example, a managed network. Specifically, the security apparatus may be installed at a position that serves as an exit of data transmitted from the managed network to the Internet or as an entrance from the Internet to the managed network. The security apparatus monitors cyber attacks on the managed network. In other words, the security apparatus monitors cyber attacks against a communication apparatus or the like in the managed network.

The security apparatus may be, for example, an apparatus for executing a firewall, IPS (Intrusion Prevention System), IDS (Intrusion Detection System), or the like. The data indicating a suspected occurrence of a cyber attack may be, for example, data indicating an unauthorized intrusion or unauthorized access to the managed network. The data indicating an unauthorized intrusion or unauthorized access to the managed network may be, for example, data transmitted from a third party or a communication apparatus not permitted to access the managed network to a communication apparatus in the managed network. Specifically, the data indicating a suspected occurrence of a cyber attack may be data detected by executing an IDS or IPS.

The communication pattern may be a communication pattern indicating normal communication or a communication pattern indicating abnormal communication. The data indicating a suspected occurrence of a cyber attack may be, for example, data indicating a communication pattern that does not correspond to a communication pattern indicating normal communication. Alternatively, the data indicating a suspected occurrence of a cyber attack may be data indicating a communication pattern corresponding to a communication pattern indicating abnormal communication.

The security information may be information for identifying data indicating a suspected occurrence of a cyber attack. For example, the security information may be information indicating at least one of a transmission destination and a transmission source of data indicating a suspected occurrence of a cyber attack. Alternatively, the security information may be parameter information indicated in a header of data indicating a suspected occurrence of a cyber attack.

The determination unit 12 determines whether or not the security information satisfies a coverage trigger condition by using a database for managing the coverage trigger conditions for defining coverage criterion of the cyber insurance. For example, the security information and coverage trigger conditions may be managed in the database in association with each other. Alternatively, in the database, statistical information and the like of the security information determined based on a plurality of pieces of the security information may be managed in association with the coverage trigger conditions. The database may be stored in a memory or the like in the management apparatus 10, or may be stored in a memory or the like externally mounted on the management apparatus 10. Alternatively, the database may be stored in a memory or the like of an apparatus different from the management apparatus 10.

As described above, the management apparatus 10 can collect data detected based on the communication pattern of data and suspected that a cyber attack has occurred. Further, the management apparatus 10 can determine whether or not the security information satisfies the coverage trigger condition by using the security information related to the collected data and the coverage trigger condition.

That is, the management apparatus 10 can determine whether or not data is covered by the insurance based on data detected before actual damage occurs in the network managed by the cyber insurance policyholder. In this way, since the management apparatus 10 can determine whether or not data is covered by the insurance at an early stage, it is possible to reduce the number of undeclared claims from the policyholder for the cyber insurance.

### Second Example Embodiment

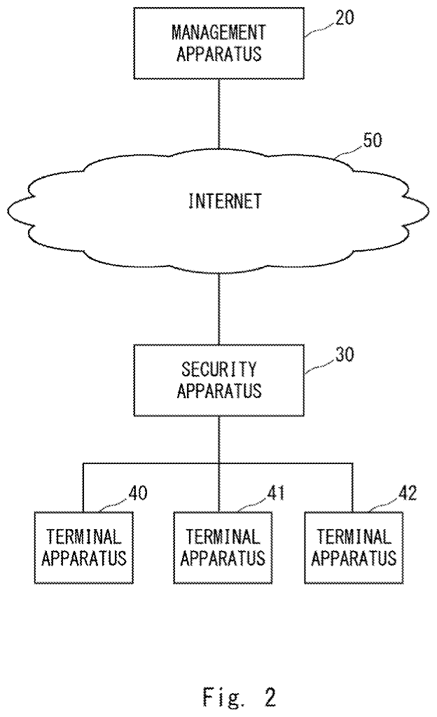

Next, a configuration example of a network monitoring system according to a second example embodiment will be described with reference to FIG. 2. The network monitoring system of FIG. 2 includes a management apparatus 20, a security apparatus 30, and terminal apparatuses 40 to 42. The security apparatus 30 and the management apparatus 20 are connected via the Internet 50. The connected state may be a state in which the security apparatus 30 and the management apparatus 20 can communicate with each other. Alternatively, an intranet, which is a closed network within the company, may be used instead of the Internet 50. The management apparatus 20 corresponds to the management apparatus 10 shown in FIG. 1.

The management apparatus 20, the security apparatus 30, and the terminal apparatuses 40 to 42 may be computer apparatuses that operate when a processor executes a program stored in a memory.

The terminal apparatuses 40 to 42 may be, for example, computer apparatuses connected to an internal LAN which is a managed network. The internal LAN may be, for example, Ethernet (registered trademark). For example, the terminal apparatuses 40 to 42 may be computer apparatuses capable of communication via a network such as a personal computer, a server apparatus, and a printer apparatus. Alternatively, the terminal apparatuses 40 to 42 may be connected to the internal LAN via a wireless communication line. In this case, the terminal apparatuses 40 to 42 may be smartphone terminals, notebook personal computers, or the like. The terminal apparatuses 40 to 42 may use a wireless LAN or a mobile line such as LTE (Long Term Evolution) or 5G as wireless communication.

The security apparatus 30 is disposed between the terminal apparatuses 40 to 42 and the Internet 50. For example, an optical communication line may be used between the security apparatus 30 and the Internet 50. An optical communication line or the like may also be used between the management apparatus 20 and the Internet 50. The security apparatus 30 may be provided to a cyber insurance policyholder by an insurance company providing cyber insurance or a company or the like entrusted by a company providing the cyber insurance.

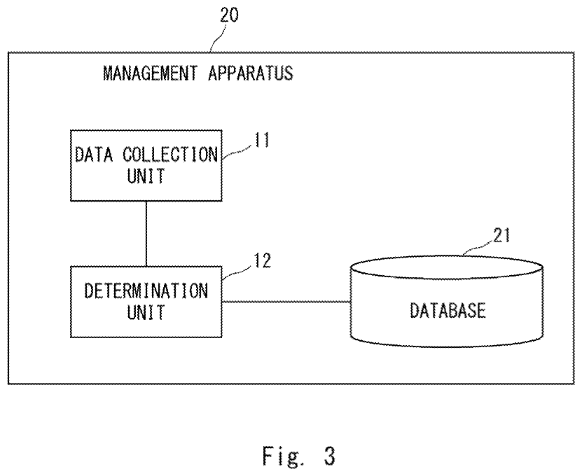

Next, a configuration example of the management apparatus 20 according to the second example embodiment will be described with reference to FIG. 3. The management apparatus 20 has a configuration further including a database 21 in addition to the configuration of the management apparatus 10 shown in FIG. 1. Hereinafter, the configuration and functions of the management apparatus 20 different from those of the management apparatus 10 shown in FIG. 1 will be mainly described.

The database 21 may be stored in a memory or the like in the management apparatus 20, or may be stored in a memory or the like externally mounted on the management apparatus 20.

A data collection unit 11 collects security information from the terminal apparatuses 40 to 42. The security information may be, for example, information indicating at least one of a transmission source of data and a transmission destination of data detected by the security apparatus 30. The information indicating the transmission source and transmission destination of the data may be, for example, an IP (Internet Protocol) address, a MAC (Media Access Control) address, or the like.

Alternatively, the security information may be information indicating a communication pattern of data. The communication pattern may be a pattern obtained by analyzing various information pieces or parameters obtained from the data. The information obtained from the data may be, for example, a transmission source address, a transmission destination address, a port number, a data size or the like indicated in an IP header or TCP (Transmission Control Protocol)/UDP (User Datagram Protocol) header of the data. The analysis may be performed by, for example, machine learning. The data collection unit 11 may collect a communication pattern identified by the security apparatus 30. Alternatively, when the security apparatus 30 detects data by using a plurality of communication patterns indicating abnormal communication, the data collection unit 11 may collect identification information indicating the communication pattern used when the security apparatus 30 detects the data. The communication pattern indicating abnormal communication may be, for example, a pattern of data suspected that is may be attacked by, for example, a DOS (Denial of Service) attack, or an SYN flood attack.

Alternatively, the security information may be information indicating the name of a cyber attack predicted when the security apparatus 30 detects the data. For example, when the security apparatus 30 detects data suspected that it may be attacked by a DOS attack, information indicating the name of the DOS attack may be used as the security information.

Further alternatively, the security information may be information indicating the time when the security apparatus 30 has received or transmitted the data. Further alternatively, the security information may be information indicating the time when a data transmission source apparatus has transmitted the data, or information indicating the time when a data transmission destination apparatus has received the data.

Further alternatively, the security information may be information indicating a protocol applied to the data. For example, when the detected data is communicating using http (HyperText Transfer Protocol), information indicating http may be used as the security information.

The security information and coverage trigger conditions are associated with each other in the database 21. Specifically, the database 21 defines the conditions that the security information must satisfy in order to trigger an insurance coverage. In other words, the predetermined security information may be defined as the coverage trigger condition in the database 21. For example, at least one of a transmission source address and a transmission destination address may be defined as the coverage trigger condition. In this case, the insurance coverage is triggered for the cyber insurance policyholder who manages the managed network in which the data corresponding to the transmission source address or the transmission destination address defined in the coverage trigger condition is detected.

Further, as the coverage trigger condition, it may be determined that the transmission source address indicates any of the terminal apparatuses 40 to 42, and the transmission destination address indicates an apparatus outside the managed network. As described above, when the transmission source of the data is an apparatus in the managed network, there is a possibility that a third party apparatus accessing the apparatus in the managed network via the Internet 50 may be performing a so-called phishing fraud in which important information is stolen.

Alternatively, a communication pattern may be defined as the coverage trigger condition. In this case, when the communication pattern of the data transmitted as the security information corresponds to the communication pattern defined as the coverage trigger condition, the insurance coverage is triggered for the cyber insurance policyholder managing the managed network where the data is detected.

Further alternatively, a threshold of an occurrence frequency of the data is or an occurrence cycle of the data may be defined as the coverage trigger condition. For example, the thresholds of the occurrence frequency and the occurrence cycle of the data may be defined based on the security information indicating the time of the data. The insurance coverage is triggered when the occurrence frequency or occurrence cycle of the data exceeds a predetermined threshold as a condition for triggering the insurance coverage. The occurrence frequency and occurrence cycle of the data are identified using a plurality of data pieces. The occurrence frequency or occurrence cycle of the data determined by combining a plurality of data pieces may be referred to as statistical information.

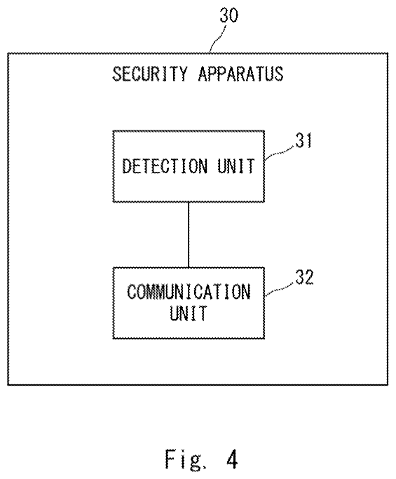

Next, a configuration example of the security apparatus 30 according to the second example embodiment will be described with reference to FIG. 4. The security apparatus 30 includes a detection unit 31 and a communication unit 32. The detection unit 31 and the communication unit 32 may be software or modules in which processing is executed when a processor executes a program stored in a memory. Alternatively, the detection unit 31 and the communication unit 32 may be hardware such as a circuit or a chip.

The detection unit 31 detects data suspected that it may be under a cyber attack based on a predetermined communication pattern. For example, the detection unit 31 may detect data indicating a communication pattern same as or similar to a communication pattern predetermined as a communication pattern suspected that data may be under a cyber attack. Alternatively, the detection unit 31 may detect data indicating a communication pattern that does not correspond to a normal communication pattern in which data is not under a cyber attack. For example, the detection unit 31 may detect data that can be detected by IDS or IPS.

Further, the detection unit 31 transmits the security information related to the detected data to the management apparatus 20 via the communication unit 32.

The communication unit 32 outputs the data received from the Internet 50 and the data received from the terminal apparatuses 40 to 42 to the detection unit 31. Further, the communication unit 32 transmits the data not detected as data suspected that it may be under a cyber attack by the detection unit 31 to either the Internet 50 or the terminal apparatuses 40 to 42. Alternatively, the communication unit 32 may transmit the data received from the Internet 50 and all the data pieces received from the terminal apparatuses 40 to 42 to a destination set in the data.

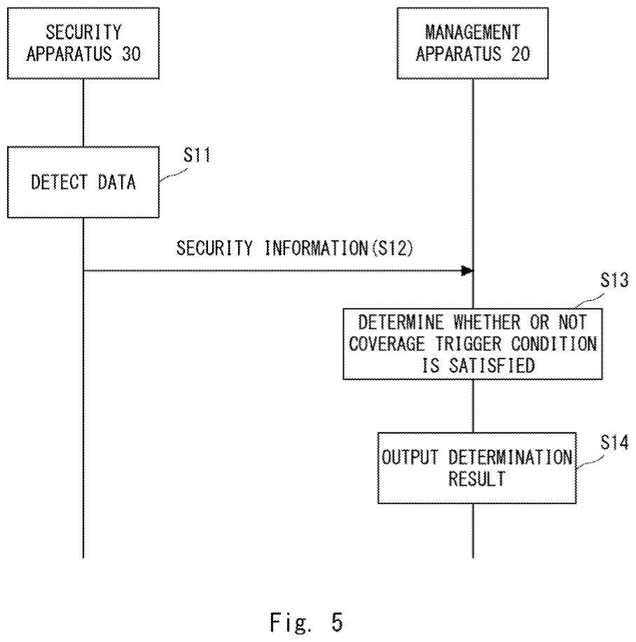

Next, a flow of determination processing related to a coverage trigger according to the second example embodiment will be described with reference to FIG. 5. First, the security apparatus 30 detects data by executing IPS or IDS (S11). Next, the security apparatus 30 transmits security information related to the detected data to the management apparatus 20 (S12). The security information related to the detected data may be, for example, address information indicating either a transmission destination or a transmission source of the data, or may be a parameter indicated in a header or the like of the data.

Next, the management apparatus 20 determines whether or not the security information received from the security apparatus 30 satisfies the coverage trigger condition defined in the database 21 (S13). Next, the management apparatus 20 outputs a determination result (S14). The determination result may be, for example, information indicating whether or not the received security information satisfies the coverage trigger condition. Specifically, the management apparatus 20 may output the determination result to a display or the like used integrally with the management apparatus 20, and display the determination result on the display or the like. Alternatively, the management apparatus 20 may transmit the determination result to the terminal apparatus held by an administrator of the management apparatus 20. For example, the management apparatus 20 may notify the administrator of the determination result by transmitting an e-mail to the terminal apparatus held by the administrator via the Internet 50, an intranet, or the like. Alternatively, the management apparatus 20 may transmit the determination result to a terminal apparatus managed by an insurance company. For example, the management apparatus 20 may notify the insurance company of the determination result by transmitting an e-mail to the terminal apparatus managed by the insurance company via the Internet 50. Alternatively, the management apparatus 20 may generate a Web page for displaying the determination result. In this case, the management apparatus 20 may transmit address information of the Web page to the terminal apparatus held by the administrator or the insurance company. The administrator or a person in charge in the insurance company can browse the Web page showing the determination result by accessing a designated address by using the terminal apparatus.

As described above, the management apparatus 20 can determine whether or not to trigger an insurance coverage by using data with a suspected occurrence of a cyber attack. As a result, since the management apparatus 20 can determine whether or not data is covered by the insurance at an early stage, it is possible to reduce the number of undeclared claims from the policyholder for the cyber insurance.

### Third Example Embodiment

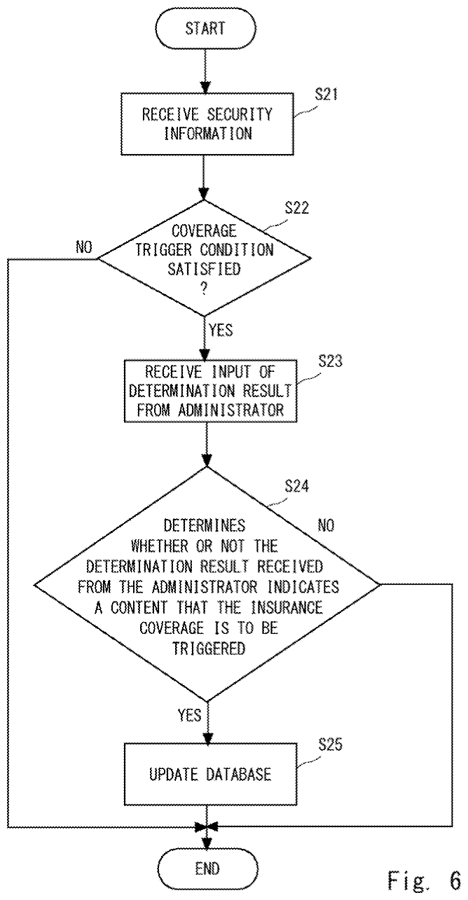

Next, a flow of database update processing in a management apparatus 20 according to a third example embodiment will be described with reference to FIG. 6. First, the determination unit 12 receives security information from the security apparatus 30 via the data collection unit 11 (S21). Next, the determination unit 12 determines whether or not the security information received from the security apparatus 30 satisfies the coverage trigger condition stored in the database 21 (S22).

When the determination unit determines that the security information does not satisfy the coverage trigger condition, the determination unit 12 receives an input of a determination result from the administrator (S23). When the security information does not satisfy the coverage trigger condition, it means that the security information does not correspond to the coverage trigger condition stored in the database 21. In other words, if the security information does not satisfy the coverage trigger condition, it means that an occurrence of a new cyber attack not defined in the database 21 is suspected in the managed network. Therefore, in such a case, it is necessary for the administrator of the management apparatus 20 to examine in detail whether an insurance coverage should be triggered for an event suspected of being a cyber attack that is found from the security information, and to determine whether the insurance coverage should be triggered. In Step S23, the determination unit 12 may receive an input of the determination result from the administrator via an input device such as a keyboard and a touch panel attached to the management apparatus 20. Alternatively, the determination unit 12 may receive the determination result from the terminal apparatus operated by the administrator via the data collection unit 11.

Next, the determination unit 12 determines whether or not the determination result received from the administrator indicates a content that the insurance coverage is to be triggered (S24). When the determination result received from the administrator indicates that the insurance coverage is to be triggered, the determination unit 12 updates the coverage trigger condition of the database 21 (S25). Specifically, the determination unit 12 adds the security information that caused the insurance coverage to be triggered to the database 21 as a new coverage trigger condition. In this way, a content related to a threat of a newly generated cyber attack is added to the database 21.

If the security information satisfies the coverage trigger condition in Step S22, and if the determination result that the insurance is not to be triggered is received in Step S24, the processing ends.

As described above, by updating the database 21, it is possible to determine whether to trigger an insurance coverage even for data which may be under a new cyber attack occuring in the managed network.

Further, in FIG. 6, the processing of updating the database 21 when the determination result that an insurance coverage is to be triggered is received has been described. However, the determination result that an insurance coverage is not to be triggered may also be added to the database 21 or a new database. Specifically, the determination unit 12 may add, to the database, the security information that caused the insurance coverage not to be triggered. The determination unit 12 also manages the determination result that an insurance coverage is not to be triggered in the database, so that the administrator can avoid examining whether or not an insurance coverage is to be triggered based on the received security information that is the same as security information already managed in the database. In other words, if the received security information matches the security information already managed in the database which manages the determination results that an insurance coverage is not to be triggered, the determination unit 12 may determine that the insurance coverage is not to be triggered without accepting an input from the administrator.

### Fourth Example Embodiment

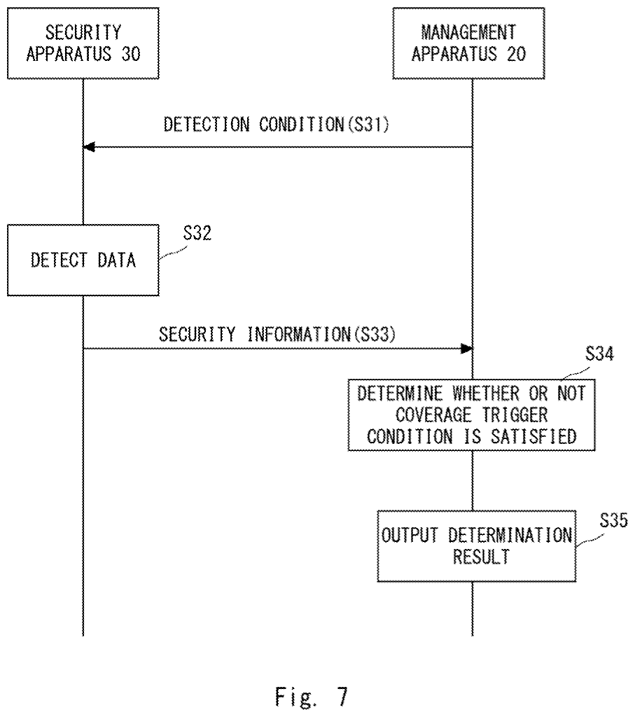

Next, a flow of determination processing related to a coverage trigger according to a fourth example embodiment will be described with reference to FIG. 7. First, the management apparatus 20 transmits a detection condition of data with a suspected occurrence of a cyber attack to the security apparatus 30 (S31). For example, the management apparatus 20 may define, as the detection condition, a detection of data satisfying a coverage trigger condition managed in the database 21. In Step S11 of FIG. 5, the security apparatus 30 detects data corresponding to a predetermined communication pattern set by the security apparatus 30. However, in FIG. 7, data corresponding to the detection condition set by the management apparatus 20 is detected.

Steps S32 to S35 are the same as Steps S11 to S14 in FIG. 5, respectively, and thus the detailed description of Steps S32 to S35 is omitted.

As described above, in the determination processing related to the coverage trigger condition according to the fourth example embodiment, the management apparatus 20 determines the detection condition of the data with a suspected occurrence of a cyber attack and transmits the data to the security apparatus 30. Thus, the data detected by the security apparatus 30 is data satisfying the coverage trigger condition managed by the management apparatus 20. In other words, the security apparatus 30 detects data only from the data satisfying the detection condition determined by the management apparatus 20. As a result, in Step S33, an amount of data of the security information transmitted from the security apparatus 30 to the management apparatus 20 can be reduced.

In FIG. 7, an example in which the security apparatus 30 detects the data satisfying the detection condition received from the management apparatus 20 in Step S32 has been described. Alternatively, the security apparatus 30 may detect data in the same manner as in Step S11 of FIG. 5. After that, when the security information is transmitted to the management apparatus 20, the security apparatus 30 may transmit only the security information satisfying the detection condition to the management apparatus 20. Also in this case, the amount of data of the security information transmitted from the security apparatus 30 to the management apparatus 20 can be reduced.

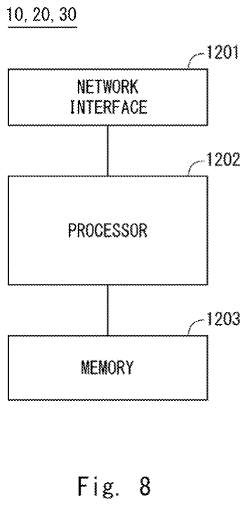

FIG. 8 is a block diagram showing a configuration example of the management apparatus 10, the management apparatus 20, and the security apparatus 30 (hereinafter referred to as the management apparatus 10 and so on). Referring to FIG. 8, each of the management apparatus 10 and so on includes a network interface 1201, a processor 1202, and a memory 1203. The network interface 1201 is used to communicate with network nodes (e.g., eNB, MME, P-GW). The network interface 1201 may include, for example, a network interface card (NIC) compliant with IEEE 802.3 series.

The processor 1202 reads and executes software (computer programs) from the memory 1203 to perform the processing of the management apparatus 10 and so on described with reference to the flowchart in the above example embodiments. The processor 1202 may be, for example, a microprocessor, MPU, or CPU. The processor 1202 may include a plurality of processors.

The memory 1203 is composed of a combination of a volatile memory and a non-volatile memory. The memory 1203 may include a storage disposed separately from the processor 1202. In this case, the processor 1202 may access the memory 1203 via the network interface 1203 or an I/O interface not shown.

In the example of FIG. 8, the memory 1203 is used to store software modules. The processor 1202 reads these software modules from the memory 1203 and executes them to perform the processing of the management apparatus 10 and the like described in the above example embodiments.

As described with reference to FIG. 8, each of the processors included in the management apparatus 10 and so on according to the above-described example embodiments includes one or more programs including instructions for causing a computer to execute the algorithm described with reference to the drawings.

In this example, these programs can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD Read Only Memory (CD-ROM), CD-R, CD-R/W, semiconductor memories (such as Mask ROM, Programmable ROM (PROM), Erasable PROM (EPROM), flash ROM, Random Access Memory (RAM)). These programs may be provided to a computer using any type of transitory computer readable media. Examples of transitory computer readable media include electric signals, optical signals, and electromagnetic waves. Transitory computer readable media can be used to provide programs to a computer via a wired communication line (e.g., electric wires and optical fibers) or a wireless communication line.

Note that the present disclosure is not limited to the example embodiment described above, and may be changed as necessary without departing from the spirit thereof.

The whole or part of the example embodiments disclosed above can be described as, but not limited to, the following supplementary notes.

(Supplementary Note 1)

A management apparatus comprising:

a data collection unit configured to collect, from a security apparatus configured to monitor a network managed by a cyber insurance policyholder, security information related to data indicating a suspected occurrence of a cyber attack and detected based on a predetermined communication pattern; and

a determination unit configured to determine whether or not the security information satisfies a coverage trigger condition by using a database for managing the coverage trigger condition, the coverage trigger condition defining a coverage criteria of cyber insurance.

(Supplementary Note 2)

The management apparatus according to Supplementary note 1, wherein

the security information includes information indicating a transmission source of the data indicating the suspected occurrence of the cyber attack, and

the determination unit determines that the security information satisfies the coverage trigger condition when a communication source of the data is a communication apparatus in the network.

(Supplementary Note 3)

The management apparatus according to Supplementary note 1 or 2, wherein

the security information includes an occurrence timing of the data, and

the determination unit determines that the security information satisfies the coverage trigger condition when an occurrence frequency or an occurrence cycle of the data exceeds a threshold.

(Supplementary Note 4)

The management apparatus according to any one of Supplementary notes 1 to 3, wherein

the determination unit collects data satisfying a predetermined detection condition from among the data detected by the security apparatus.

(Supplementary Note 5)

The management apparatus according to any one of Supplementary notes 1 to 4, wherein

the determination unit outputs the determination result as to whether or not the coverage trigger condition is satisfied to a display unit used integrally with the management apparatus or transmits the determination result as to whether or not the coverage trigger condition is satisfied to a terminal apparatus different from the management apparatus.

(Supplementary Note 6)

A security apparatus for monitoring a network managed by a cyber insurance policyholder, the security apparatus comprising:

a detection unit configured to detect data indicating a suspected occurrence of a cyber attack based on a predetermined communication pattern; and

a communication unit configured to transmit, to a management apparatus, security information related to data satisfying a detection condition determined by the management apparatus for determining whether or not the security information related to the data satisfies a coverage trigger condition from among the data, the coverage trigger condition defining a coverage criteria of cyber insurance.

(Supplementary Note 7)

The security apparatus according to Supplementary note 6, further comprising a display unit configured to display a determination result indicating whether or not the security information transmitted to the management apparatus satisfies the coverage trigger condition.

(Supplementary Note 8)

A network monitoring system comprising:

a security apparatus configured to monitor a network managed by a cyber insurance policyholder and detect data indicating a suspected occurrence of a cyber attack based on a predetermined communication pattern; and

a management apparatus configured to collect security information related to the detected data from the security apparatus and determine whether or not the security information satisfies a coverage trigger condition by using a database for managing the coverage trigger condition, the coverage trigger condition defining a coverage criteria of cyber insurance.

(Supplementary Note 9)

The network monitoring system according to Supplementary note 8, wherein

the security information includes information indicating a transmission source of the data indicating the suspected occurrence of the cyber attack, and

the management apparatus determines that the security information satisfies the coverage trigger condition when a communication source of the data is a communication apparatus in the network.

(Supplementary Note 10)

The network monitoring system according to Supplementary note 8 or 9, wherein

the security information includes an occurrence timing of the data, and

the management apparatus determines that the security information satisfies the coverage trigger condition when an occurrence frequency or an occurrence cycle of the data exceeds a threshold.

(Supplementary Note 11)

The network monitoring system according to any one of Supplementary notes 8 to 10, wherein

the management apparatus collects data satisfying a predetermined detection condition from among the data detected by the security apparatus.

(Supplementary Note 12)

The network monitoring system according to any one of Supplementary notes 8 to 11, wherein

the management apparatus outputs the determination result as to whether or not the coverage trigger condition is satisfied to a display unit used integrally with the management apparatus or transmits the determination result as to whether or not the coverage trigger condition is satisfied to a terminal apparatus different from the management apparatus.

(Supplementary Note 13)

A determination method comprising:

collecting, from a security apparatus configured to monitor a network managed by a cyber insurance policyholder, security information related to data indicating a suspected occurrence of a cyber attack and detected based on a predetermined communication pattern; and

determining whether or not the security information satisfies a coverage trigger condition by using a database for managing the coverage trigger condition, the coverage trigger condition defining a coverage criteria of cyber insurance.

(Supplementary Note 14)

A communication method executed by a security apparatus for monitoring a network managed by a cyber insurance policyholder, the communication method comprising:

detecting data indicating a suspected occurrence of a cyber attack based on a predetermined communication pattern; and

transmitting, to a management apparatus, security information related to data satisfying a detection condition determined by the management apparatus for determining whether or not the security information related to the data satisfies a coverage trigger condition from among the data, the coverage trigger condition defining a coverage criteria of cyber insurance.

(Supplementary Note 15)

A program for causing a computer to execute:

collecting, from a security apparatus configured to monitor a network managed by a cyber insurance policyholder, security information related to data indicating a suspected occurrence of a cyber attack and detected based on a predetermined communication pattern; and

determining whether or not the security information satisfies a coverage trigger condition by using a database for managing the coverage trigger condition, the coverage trigger condition defining a coverage criteria of cyber insurance. (Supplementary Note 16)

A program for causing a computer to execute a communication method executed by a security apparatus for monitoring a network managed by a cyber insurance policyholder, the communication method comprising:

detecting data indicating a suspected occurrence of a cyber attack based on a predetermined communication pattern; and

transmitting, to a management apparatus, security information related to data satisfying a detection condition determined by the management apparatus for determining whether or not the security information related to the data satisfies a coverage trigger condition from among the data, the coverage trigger condition defining a coverage criteria of cyber insurance.

### REFERENCE SIGNS LIST

10 MANAGEMENT APPARATUS

11 DATA COLLECTION UNIT

12 DETERMINATION UNIT

20 MANAGEMENT APPARATUS

21 DATABASE

30 SECURITY APPARATUS

31 DETECTION UNIT

32 COMMUNICATION UNIT

40 TERMINAL APPARATUS

41 TERMINAL APPARATUS

42 TERMINAL APPARATUS

50 INTERNET

What is claimed is:

1. A management apparatus comprising:
at least one memory storing instructions, and
at least one processor configured to execute the instructions to;
collect, from a security apparatus configured to monitor a network managed by a cyber insurance policyholder, security information related to data indicating a suspected occurrence of a cyber attack and detected based on a predetermined communication pattern; and
determine whether or not the security information satisfies a coverage trigger condition by using a database for managing the coverage trigger condition, the coverage trigger condition defining a coverage criteria of cyber insurance.

2. The management apparatus according to claim 1, wherein
the security information includes information indicating a transmission source of the data indicating the suspected occurrence of the cyber attack, and
the at least one processor is further configured to execute the instructions to determine that the security information satisfies the coverage trigger condition when a communication source of the data is a communication apparatus in the network.

3. The management apparatus according to claim 1, wherein
the security information includes an occurrence timing of the data, and
the at least one processor is further configured to execute the instructions to determine that the security information satisfies the coverage trigger condition when an occurrence frequency or an occurrence cycle of the data exceeds a threshold.

4. The management apparatus according to claim 1, wherein
the at least one processor is further configured to execute the instructions to collect data satisfying a predetermined detection condition from among the data detected by the security apparatus.

5. The management apparatus according to claim 1, wherein
the at least one processor is further configured to execute the instructions to output the determination result as to whether or not the coverage trigger condition is satisfied to display means used integrally with the management apparatus or transmits the determination result as to whether or not the coverage trigger condition is satisfied to a terminal apparatus different from the management apparatus.

6. A security apparatus for monitoring a network managed by a cyber insurance policyholder, the security apparatus comprising:
at least one memory storing instructions, and
at least one processor configured to execute the instructions to;
detect data indicating a suspected occurrence of a cyber attack based on a predetermined communication pattern; and
transmit, to a management apparatus, security information related to data satisfying a detection condition determined by the management apparatus for determining whether or not the security information related to the data satisfies a coverage trigger condition from among the data, the coverage trigger condition defining a coverage criteria of cyber insurance.

7. The security apparatus according to claim 6, wherein
the at least one processor is further configured to execute the instructions to display a determination result indicating whether or not the security information transmitted to the management apparatus satisfies the coverage trigger condition.

8. A network monitoring system comprising:
a security apparatus; and
a management apparatus:
wherein the security apparatus comprises;
at least one memory storing instructions, and
at least one processor configured to execute the instructions to;
monitor a network managed by a cyber insurance policyholder and detect data indicating a suspected occurrence of a cyber attack based on a predetermined communication pattern; and
wherein the management apparatus comprises;
at least one memory storing instructions, and
at least one processor configured to execute the instructions to;
collect security information related to the detected data from the security apparatus and determine whether or not the security information satisfies a coverage trigger condition by using a database for managing the coverage trigger condition, the coverage trigger condition defining a coverage criteria of cyber insurance.

9. The network monitoring system according to claim 8, wherein
the security information includes information indicating a transmission source of the data indicating the suspected occurrence of the cyber attack, and
the at least one processor of the management apparatus is further configured to execute the instructions to determine that the security information satisfies the coverage trigger condition when a communication source of the data is a communication apparatus in the network.

10. The network monitoring system according to claim 8, wherein
the security information includes an occurrence timing of the data, and
the at least one processor of the management apparatus is further configured to execute the instructions to determine that the security information satisfies the coverage trigger condition when an occurrence frequency or an occurrence cycle of the data exceeds a threshold.

11. The network monitoring system according to claim 8, wherein
the at least one processor of the management apparatus is further configured to execute the instructions to collect data satisfying a predetermined detection condition from among the data detected by the security apparatus.

12. The network monitoring system according to claim 8, wherein
the at least one processor of the management apparatus is further configured to execute the instructions to output the determination result as to whether or not the coverage trigger condition is satisfied to display means used integrally with the management apparatus or transmit the determination result as to whether or not the coverage trigger condition is satisfied to a terminal apparatus different from the management apparatus.

13. A determination method comprising:
collecting, from a security apparatus configured to monitor a network managed by a cyber insurance policyholder, security information related to data indicating a suspected occurrence of a cyber attack and detected based on a predetermined communication pattern; and
determining whether or not the security information satisfies a coverage trigger condition by using a database for managing the coverage trigger condition, the coverage trigger condition defining a coverage criteria of cyber insurance.

14. A communication method executed by a security apparatus for monitoring a network managed by a cyber insurance policyholder, the communication method comprising:
detecting data indicating a suspected occurrence of a cyber attack based on a predetermined communication pattern; and
transmitting, to a management apparatus, security information related to data satisfying a detection condition determined by the management apparatus for determining whether or not the security information related to the data satisfies a coverage trigger condition from among the data, the coverage trigger condition defining a coverage criteria of cyber insurance.

15. A non-transitory computer readable medium storing a program for causing a computer to execute:
collecting, from a security apparatus configured to monitor a network managed by a cyber insurance policyholder, security information related to data indicating a suspected occurrence of a cyber attack and detected based on a predetermined communication pattern; and
determining whether or not the security information satisfies a coverage trigger condition by using a database for managing the coverage trigger condition, the coverage trigger condition defining a coverage criteria of cyber insurance.

16. A non-transitory computer readable medium storing a program for causing a computer to execute a communication method executed by a security apparatus for monitoring a network managed by a cyber insurance policyholder, the communication method comprising:
detecting data indicating a suspected occurrence of a cyber attack based on a predetermined communication pattern; and
transmitting, to a management apparatus, security information related to data satisfying a detection condition determined by the management apparatus for determining whether or not the security information related to the data satisfies a coverage trigger condition from among the data, the coverage trigger condition defining a coverage criteria of cyber insurance.
